(19) United States
(12) Patent Application Publication
(10) Pub. No.: US 2006/0204300 A1
(43) Pub. Date: Sep. 14, 2006

(54) Image forming apparatus and sheet feeding method

(75) Inventors: Kazumasa Yasui, Arakawa-ku (JP); Masaya Arakawa, Hiratsuka-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/232,944

(22) Filed: Sep. 23, 2005

(30) Foreign Application Priority Data
Mar. 9, 2005 (JP) 2005-065026

(51) Int. Cl. G03G 15/00

(52) U.S. Cl. 399/401

(57) ABSTRACT

The present invention has been made to provide an image forming apparatus, a sheet feeding method, and a sheet feeding program capable of eliminating the problem that the leading end of a sheet hits against the bottom portion of a reverse feeding path and contributing to an increase in sheet feeding efficiency without adding special parts and preventing the miniaturization of the entire apparatus.

An image forming apparatus comprises a drive control section 101 that controls drive of feeding rollers that guide a sheet to a reverse feeding path and then feed the sheet in a switchback manner; and a sheet information acquisition section 102 that acquires information relating to the sheet size in the feeding direction of a sheet to be switched back. The drive control section 101 controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition section 102 has acquired.

### BACKGROUND OF THE INVENTION

1. Field of the Invention

The present invention relates to an image forming apparatus and a sheet feeding method.

2. Description of the Related Art

Conventionally, an image forming apparatus having a configuration in which a sheet that has been subjected to a toner image transfer process and fixing process is guided to a reverse feeding path and the sheet is then fed in a switchback manner (feeding direction of the sheet is switched to the opposite direction) has been known (refer to, for example, Jpn. Pat. Appln. Laid-Open Publication No. 2001-130811 (pages 6 to 12, FIG. 2)). FIG. 5 is a cross-sectional view showing the entire configuration of a conventional image forming apparatus. FIG. 6 is an enlarged view of the area surrounded by the dotted line in FIG. 5.

The following processing is performed in the image forming apparatus shown in FIGS. 5 and 6. Firstly, paper sheets stacked in cassettes 31, 32, 33, or 34 are sequentially picked up by a pick-up roller 31b, 32b, 33b, or 34b. The picked up paper sheets are separated one by one by separating rollers 31a, 32a, 33a, or 34a and fed to a sheet feeding path 35. The paper sheet that has been fed to the sheet feeding path 35 is then fed to the portion in front of an intermediate feeding roller 38 by feeding rollers 36a, 36b, 36c, or 36d. The intermediate feeding roller 38 has a role of guiding the sheet that has been fed by an ADU 5 (to be described later) or sheet that has been fed along the sheet feeding path 35 to a resist roller 37 that performs skew correction or timing adjustment.

The sheet that has been guided to the resist roller 37 through the intermediate feeding roller 38 is subjected to the skew correction or timing adjustment. After that, a toner image formed on a photoconductor surface of a photoconductor drum 20 is transferred onto the sheet. The toner image that has been transferred onto the sheet is fixed to the sheet in a fixing section 24. In the case of one-side printing, the sheet onto which the toner image has been fixed is directly discharged outside the apparatus (denoted by the arrow D in FIG. 5). In the case where the duplex printing is performed or one-side printed sheet is reversed before being discharged outside, the sheet is guided to a reverse feeding path 28.

In the case of the duplex printing, the sheet that has been guided to the reverse feeding path 28 is fed to the ADU 5 in a switchback manner by reverse rollers 29 and 30. The sheet that has been fed to the ADU 5 is then fed to the intermediate feeding roller 38 again by feeding rollers 5a to 5d. After that, image forming processing is performed for the other surface of the sheet that has been fed through the ADU 5 by the photoconductor drum 20 and fixing section 24. Thus, the duplex printing for the sheet has been completed.

In the case where the one-side printed sheet is reversed before being discharged outside, the sheet that has been guided to the reverse feeding path 28 is fed in a switchback manner by the reverse rollers 29 and 30 and discharged outside the apparatus in the direction along the arrow D.

In the case where the one-side printed sheet is reversed before being discharged outside in the conventional image forming apparatus, the sheet is introduced in the reverse feeding path 28 until the rear end of the sheet has reached an introduction position R1. In the case of the duplex printing, the sheet is introduced into the reverse feeding path 28 until the rear end of the sheet has reached an introduction position R2 for switchback because the sheet must be fed to the ADU 5. That is, in the case of the duplex printing, the sheet must be introduced into the reverse feeding path 28 more deeply than in the case of one-side printing.

In order to reduce the size of the entire apparatus, the length of a sheet housing space in the reverse feeding path 28 is set slightly longer than the length of a maximum size sheet (A3, in this example) that can be handled in the duplex printing.

Therefore, in the case where a sheet having a large size in the feeding direction, such as an A3 size sheet, is fed in a switchback manner as described above, if an error is generated in the sheet feeding operation by the reverse rollers 29 and 30 for some reason, or if sheet overrun occurs because of inaccurate feeding control, the leading end of a sheet hits against a bottom portion 28b of the reverse feeding path 28 at the time when the sheet is introduced (in the direction along the arrow N) into the reverse feeding path 28 in some cases. This problem is likely to occur at the duplex printing time, in particular.

Although the above problem can be suppressed by making the introduction speed of a sheet into the reverse feeding path 28 at the duplex printing time lower, when the introduction speed of the sheet into the reverse feeding path 28 is made lower irrespective of sheet size, sheet feeding efficiency in the apparatus may be decreased. Further, the above problem can be suppressed also by making the length of the sheet housing space in the reverse feeding path 28 greater. However, this approach prevents miniaturization of the entire apparatus. Furthermore, the above problem can be suppressed also by decreasing the introduction speed of a sheet into the reverse feeding path 28 at the duplex printing irrespective of the sheet size while increasing the sheet feeding speed in the ADU 5. However, in this case, performance such as drive motor performance needs to be changed, resulting in a disadvantage in terms of cost.

### SUMMARY OF THE INVENTION

The present invention has been made to solve the above problem, and an object thereof is to provide an image forming apparatus and a sheet feeding method capable of eliminating the problem that the leading end of a sheet hits against the bottom portion of the reverse feeding path and contributing to an increase in sheet feeding efficiency without adding special parts and preventing the miniaturization of the entire apparatus.

To solve the above problem, according to an aspect of the present invention, there is provided an image forming apparatus comprising: a drive control section that controls drive of feeding rollers that guide a sheet to a reverse feeding path and then feed the sheet in a switchback manner; and a sheet information acquisition section that acquires information relating to the sheet size in the feeding direction of a sheet to be switched back, wherein the drive control section controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition section has acquired.

According to another aspect of the present invention, there is provided an image forming apparatus comprising: a drive control section that controls drive of feeding rollers that guide a sheet to a reverse feeding path and then feed the sheet in a switchback manner to an image forming position where an image is to be formed on the sheet or a predetermined discharge position through which the sheet is to be discharged; and a sheet information acquisition section that acquires information relating to the sheet size in the feeding direction of a sheet to be switched back, wherein the drive control section controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition section has acquired in the case where a sheet to be switched back is fed to the image forming position where an image is to be formed on the sheet.

According to another aspect of this invention, there is provided a sheet feeding method comprising a drive control step that controls drive of feeding rollers that guide a sheet to a reverse feeding path and then feed the sheet in a switchback manner; and a sheet information acquisition step that acquires information relating to the sheet size in the feeding direction of a sheet to be switched back, wherein the drive control step controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition step has acquired.

According to another aspect of this invention, there is provided a sheet feeding method comprising a drive control step that controls drive of feeding rollers that guide a sheet to a reverse feeding path and then feed the sheet in a switchback manner to an image forming position where an image is to be formed on the sheet or a predetermined discharge position through which the sheet is to be discharged; and a sheet information acquisition step that acquires information relating to the sheet size in the feeding direction of a sheet to be switched back, wherein the drive control step controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition step has acquired in the case where a sheet to be switched back is fed to the image forming position where an image is to be formed on the sheet.

As described above in detail, according to the present invention, it is possible to provide an image forming apparatus and a sheet feeding method capable of eliminating the problem that the leading end of a sheet hits against the bottom portion of a reverse feeding path and contributing to an increase in sheet feeding efficiency without adding special parts and preventing the miniaturization of the entire apparatus.

### BRIEF DESCRIPTION OF THE DRAWINGS

FIG. 1 is a functional block diagram for explaining an image forming apparatus according to an embodiment of the present invention;

FIG. 2 is an enlarged view showing an area covering a reverse feeding path in the image forming apparatus according to the embodiment;

FIG. 3 is a flowchart showing a process flow in a sheet feeding method according to the embodiment;

FIG. 4 is a timing chart showing sheet feeding timing at the time when duplex printing is performed for A4 size sheet and A3 size sheet;

FIG. 5 is a cross-sectional view showing the entire configuration of a conventional image forming apparatus; and

FIG. 6 is an enlarged view of the area surrounded by the dotted line in FIG. 5.

### DETAILED DESCRIPTION OF THE PREFERRED EMBODIMENTS

Hereinafter, an embodiment of the present invention will be described with reference to the accompanying drawings.

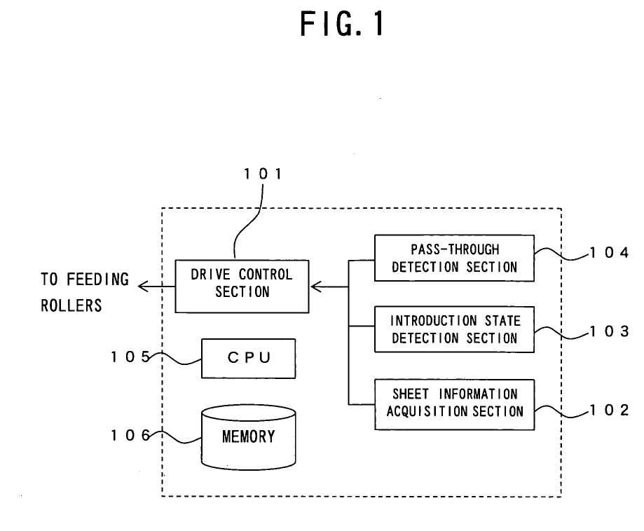

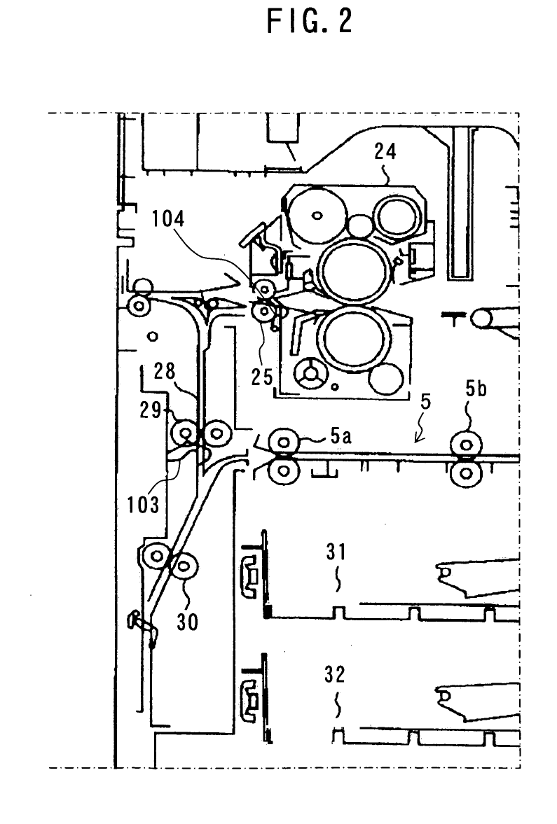

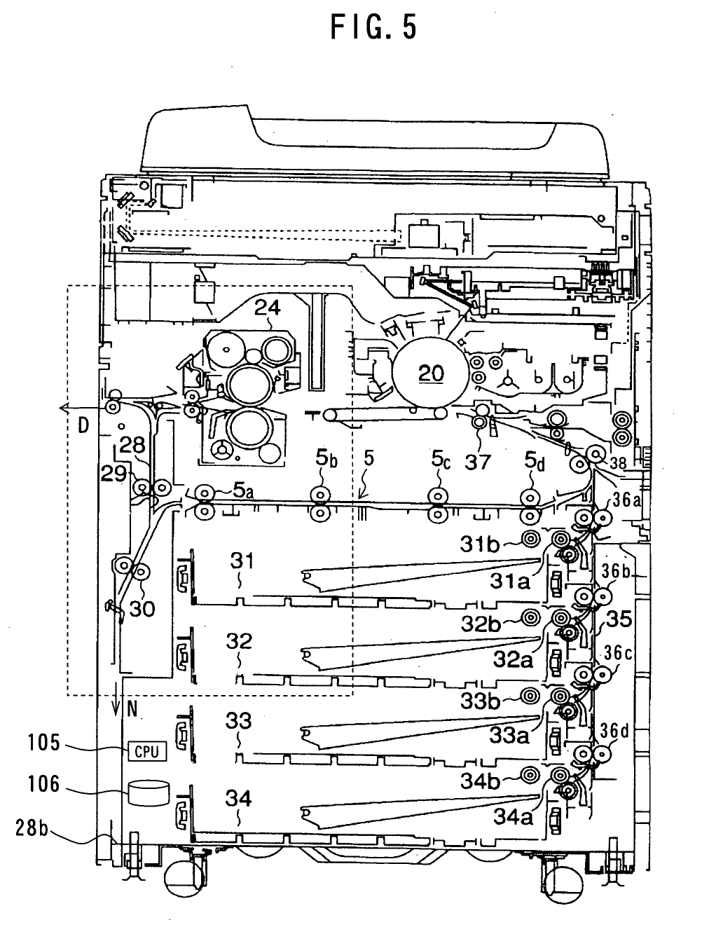

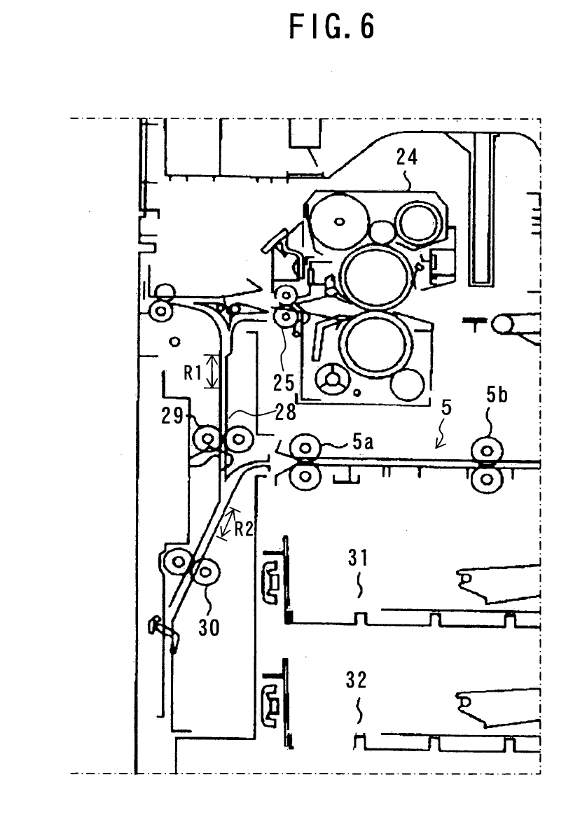

FIG. 1 is a functional block diagram for explaining an image forming apparatus according to an embodiment of the present invention, and FIG. 2 is an enlarged view showing an area covering a reverse feeding path in the image forming apparatus according to the embodiment. Since the basic configuration including a sheet feeding path and the like in the image forming apparatus according to the embodiment of the present invention is the same as that of the conventional image forming apparatus shown in FIGS. 5 and 6, the same reference numerals are given to the components which are common to FIGS. 5 and 6, and the description thereof will be omitted.

The image forming apparatus according to the embodiment includes, as shown in FIG. 1, a drive control section 101, a sheet information acquisition section 102, an introduction state detection section 103, a pass-through detection section 104, a CPU 105, and a MEMORY 106 in addition to the configuration as shown in FIG. 5.

The drive control section 101 has a role of controlling the drive of feeding rollers that guide the sheet to the reverse feeding path 28 and then feed the sheet in a switchback manner. Here, the feeding rollers include at least reverse rollers 29 and 30, which guide the sheet to the reverse feeding path 28 and, after that, feed the sheet in a switchback manner to an image forming position where image formation processing is performed for the sheet (the position where a toner image is transferred onto the sheet by the photoconductor drum 20) or a predetermined sheet discharge position (discharging port through which the sheet is discharged in the direction along the arrow D in FIG. 5).

The sheet information acquisition section 102 has a role of acquiring information relating to the sheet size (A3, A4, etc.) in the feeding direction of a sheet to be switched back. The information relating the sheet size in the feeding direction thereof can be acquired from information specifying the paper feed cassette from which the sheet is supplied, or paper information defined by information of the image to be formed on the sheet.

The pass-through detection section 104 has a role of detecting that the rear end of a sheet to be switched back has passed through the fixing section 24 for fixing a toner image to the sheet. The introduction state detection section 103 has a role of detecting that the leading end of a sheet to be switched back has reached near the reverse feeding path 28. The pass-through detection section 104 and introduction state detection section 103 are constituted by a switch or a photodetector.

Further, the drive control section 101 has a role of controlling the drive of the feeding rollers (including at least the reverse rollers 29 and 30, as above) at the time of switchback feeding operation based on the information relating to the sheet size in the feeding direction thereof, which has been acquired by the sheet information acquisition section 102, such that only the introduction speed of a sheet of a predetermined size (for example, A3) is made lower than the introduction speed of other sheet of a size (for example, A4, B5, or the like) smaller than the predetermined size. It is preferable to perform the above drive control when a sheet to be switched back needs to be fed to the image forming position where an image is formed on the sheet.

The CPU 105 has a role of performing various processing in the image forming apparatus and another role of executing a program stored in the MEMORY 106 to realize various functions. The MEMORY 106 is constituted by, for example, a ROM or RAM and has a role of storing various information and programs utilized in the image forming apparatus.

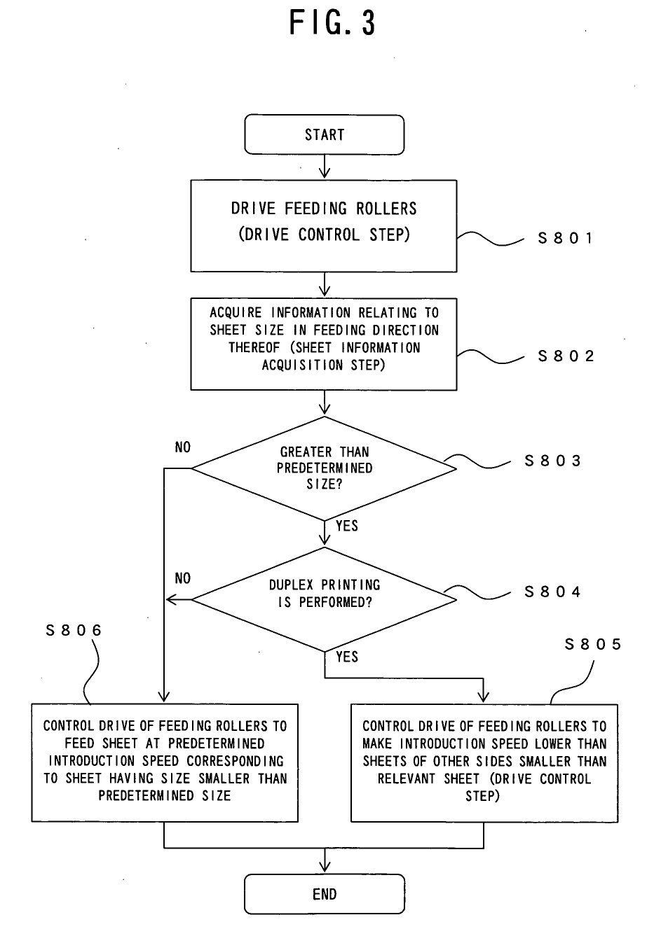

A sheet feeding method according to the embodiment will next be described. FIG. 3 is a flowchart showing a process flow in the sheet feeding method according to the embodiment.

The drive control section 101 controls drive of the feeding rollers (including at least reverse rollers 29 and 30) for guiding a sheet to the reverse feeding path 28 and feeding the sheet in a switchback manner (S801).

The sheet information acquisition section 102 acquires information relating to the sheet size in the feeding direction of a sheet to be switched back (sheet information acquisition step) (S802).

When the size of a sheet to be switched back, which has been acquired by the sheet information acquisition section 102, is smaller than a predetermined sheet size (for example, A3) (that is, when a sheet to be switched back is A4, B4, B5, or LT size sheet that is smaller than A3) (No in S803), the drive control section 101 determines that it is unlikely that the leading end of the sheet hits against the bottom portion 28b of the reverse feeding path 28 at the switchback feeding operation and controls drive of the feeding rollers in such a manner as to introduce the sheet into the reverse feeding path 28 at a predetermined sheet introduction speed set for the small size sheet (S806).

In the case where the size of the sheet (for example, A3) to be switched back is greater than a predetermined sheet size (Yes in S803), when duplex printing is not performed for the sheet, that is, the sheet is to be discharged outside the apparatus (in the direction along the arrow D in FIG. 5) after the switchback operation (No in S804), the drive control section 101 controls drive of the feeding rollers in such a manner as to introduce the sheet into the reverse feeding path 28 at a predetermined sheet introduction speed (S806) as in the above case.

In the case where the size of the sheet (for example, A3) to be switched back, which is acquired by the sheet information acquisition section 102, is greater than a predetermined sheet size (Yes in S803) and duplex printing is performed for the sheet, that is, the one-side printed sheet is fed in a switchback manner to the ADU 5 and further fed to the image forming position (Yes in S804), the drive control section 101 controls drive of the feeding rollers in such a manner as to make only the introduction speed of this sheet into the reverse feeding path lower than the introduction speed of sheets of other sizes smaller than a predetermined size (drive control step) (S805).

In the present embodiment, when detecting a sheet of a given size (for example, A4, B5, or LT size) smaller than a predetermined size, the drive control section 101 controls drive of the feeding rollers in such a manner as to make the introduction speed into the reverse feeding path 28 at the time when the sheet is to be fed to the image forming position and the introduction speed into the reverse feeding path 28 at the time when the sheet is to be fed to a predetermined discharge position substantially equal to each other. That is, by making the introduction speed of only the large size sheet that is likely to hit against the bottom portion of the reverse feeding path lower, it is possible to prevent the sheet from hitting against the bottom portion of the reverse feeding path without significantly decreasing the sheet feeding efficiency as compared to the case where the introduction speed is made lower irrespective of sheet size.

In the case where the sheet that has been subjected to the fixing process performed in the fixing section 24 is guided to the reverse feeding path 28 and fed in a switchback manner, the sheet feeding speed needs to be increased after passage of the fixing section 24 up to the introduction speed into the reverse feeding path 28.

In the present embodiment, the sheet introduction speed into the reverse feeding path 28 defined by the feeding rollers is increased up to a predetermined introduction speed at the timing when the pass-through detection section 104 detects (pass-through detection step) that the rear end of the sheet of a predetermined size (in this case, A3 size) has passed through the fixing section 24. That the sheet feeding speed is increased at the timing when the sheet has completely passed through the fixing section 24 is for suppressing occurrence of curl in the sheet after fixing process and alleviating influence of scratch damage.

On the other hand, in the case of the sheet of a size (corresponding to the given size) smaller than A3 size (the predetermined size), such as A4, B5, or LT size, the sheet introduction speed into the reverse feeding path 28 defined by the feeding rollers is set to a predetermined introduction speed at the timing when the introduction state detection section 103 detects (introduction state detection step) that the leading end of the sheet of the given size has reached near the reverse feeding path 28.

As described above, since the time needed for the small size sheet such as A4, B5, or LT size to be switched back is small, there is no need to wait for the sheet to completely pass through the fixing section 24 or provide a sufficient margin for the fixing section 24. Therefore, by setting the detection timing of the introduction state detection section 103 as a trigger, it is possible to perform the reverse feeding control more effectively.

The respective steps of the process in the sheet feeding method are realized when the CPU 105 executes a sheet feeding program stored in the MEMORY 106.

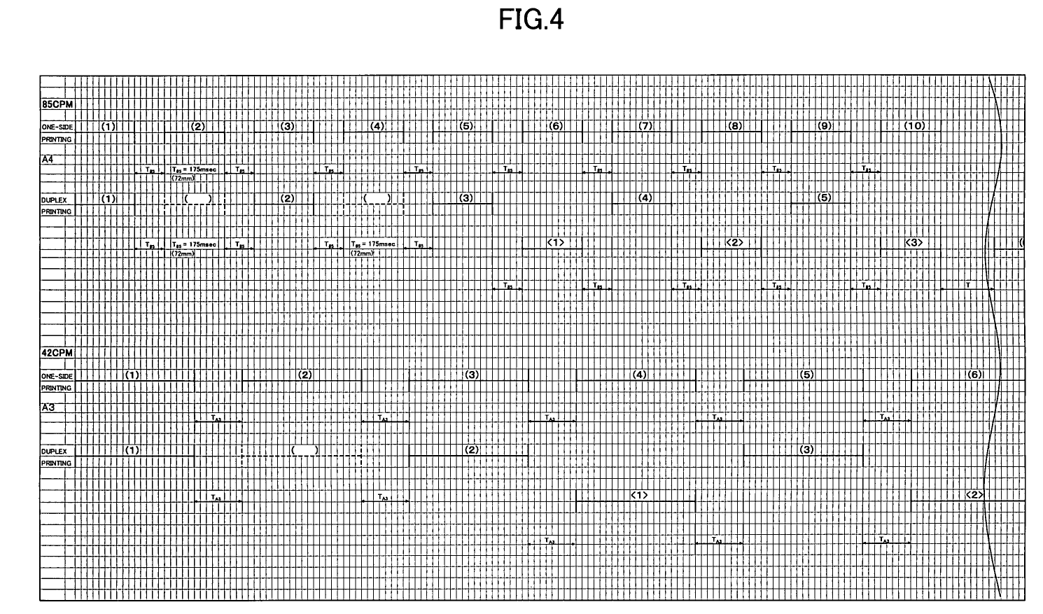

FIG. 4 is a timing chart showing sheet feeding timing at the time when duplex printing is performed for A4 size sheet and A3 size sheet. The upper half of FIG. 4 shows a timing chart in the case where five A4 size sheets are fed in a switchback manner (85 CPM (Copy Per Minute)), and the lower half shows a timing chart in the case where five A3 size sheets are fed in a switchback manner (42CPM). Further, in the timing charts of the respective sheet sizes, upper halves show the case where the one-side printed sheet is reversed before being discharged outside, and lower halves show the case where duplex printing is performed.

In the case of the duplex printing for A4 size sheets, images are formed in the order of: front (1) of first sheet, front (2) of second sheet, front (3) of third sheet, back <1> of first sheet, front (4) of fourth sheet, back <2> of second sheet, front (5) of fifth sheet, back <3> of third sheet, back <4> of fourth sheet, and back <5> of fifth sheet.

In the case of the duplex printing for A3 size sheets, images are formed in the order of: front (1) of first sheet, front (2) of second sheet, back <1> of first sheet, front (3) of third sheet, back <2> of second sheet, front (4) of fourth sheet, back <3> of third sheet, front (5) of fifth sheet, back <4> of fourth sheet, and back <5> of fifth sheet.

In the case of A4/Lt size (85 CPM), the time needed for processing five sheets can be calculated as follows:
60 sec÷85 CPM×5 sheet=3.529 sec

In the case of A3/LD size (42 CPM), the time needed for processing three sheets can be calculated as follows:
60 sec÷42 CPM×3 sheets=4.286 sec

As described above, the sheet feeding time at the image forming time (process speed: 410 mm/sec) is greater in terms of A3/LD size than in terms of A4/LT size. Accordingly, the timing at which the switched back sheet is fed to the image forming section comes late. Thus, there is no problem in decreasing the introduction speed into the reverse feeding path 28.

A function that realizes the invention has previously been recorded in the interior of the apparatus in the above embodiment. Alternatively, however, it is possible to obtain the same function by downloading it from a network to the apparatus or installing the same function that has been stored in a recording medium on the apparatus. As the recording medium, it is possible to use any type of recording medium (CD-ROM, etc) as far as it can store a program and is computer-readable. Further, the function previously obtained by the installation or download may realize its function by cooperating with an OS (Operating System) in the interior of the apparatus.

As the sheet onto which an image is to be formed, a copy paper is used in the above embodiment. Alternatively, however, an OHP film or a heavy paper may be used.

As described above, according to the present invention, it is possible to increase efficiency of reverse feeding operation in the sheet feeding process and contribute to a decrease in drive noise or paper feeding noise at the paper feeding time, by making the speed of a sheet into the reverse feeding path at the duplex printing time lower. Further, it is possible to perform the duplex printing with the same sheet feeding efficiency as in the case where the one-side printed sheet is reversed before being discharged outside without allowing the sheet to hit against the bottom portion of the reverse feeding path at the time of switchback feeding operation in the duplex printing.

While the present invention has been described in detail according to the specific embodiment, it will be apparent to those skilled in the art that variations and modifications are possible without deviating from the broad principles and spirit of the present invention.

What is claimed is:

1. An image forming apparatus comprising:
a drive control section that controls drive of feeding rollers that guide a sheet to a reverse feeding path and then feed the sheet in a switchback manner; and
a sheet information acquisition section that acquires information relating to the sheet size in the feeding direction of a sheet to be switched back, wherein
the drive control section controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition section has acquired.

2. An image forming apparatus comprising:
a drive control section that controls drive of feeding rollers that guide a sheet to a reverse feeding path and then feed the sheet in a switchback manner to an image forming position where an image is to be formed on the sheet or a predetermined discharge position through which the sheet is to be discharged; and
a sheet information acquisition section that acquires information relating to the sheet size in the feeding direction of a sheet to be switched back, wherein
the drive control section controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition section has acquired in the case where a sheet to be switched back is fed to the image forming position where an image is to be formed on the sheet.

3. The image forming apparatus according to claim 1, wherein
the feeding rollers feed the sheet that has been fed in a switchback manner from the reverse feeding path to an image forming position where an image is to be formed on the sheet or a predetermined discharge position through which the sheet is to be discharged, and
the drive control section controls drive of the feeding rollers for a given sheet having a size smaller than the predetermined size in such a manner as to make the introduction speed into the reverse feeding path at the time when the sheet is to be fed to the image forming position and the introduction speed into the reverse feeding path at the time when the sheet is to be fed to a predetermined discharge position substantially equal to each other.

4. The image forming apparatus according to claim 1, further comprising:
a pass-through detection section that detects the rear end of a sheet to be switched back has passed through a fixing section that fixes a toner image to the sheet, wherein
the drive control section controls drive of the feeding rollers in such a manner as to introduce a sheet into the reverse feeding path at a predetermined sheet introduction speed when the pass-through detection section detects that the rear end of a sheet of the predetermined size has passed through the fixing section.

5. The image forming apparatus according to claim 1, further comprising:
an introduction state detection section that detects the leading end of a sheet to be switched back has reached near the reverse feeding path, wherein
the drive control section controls drive of the feeding rollers in such a manner as to introduce a sheet into the reverse feeding path at a predetermined sheet introduction speed when the introduction state detection section detects that the leading end a given sheet having a size smaller than the predetermined size has reached near the reverse feeding path.

6. A sheet feeding method comprising:
a drive control step that controls drive of feeding rollers that guide a sheet to a reverse feeding path and then feed the sheet in a switchback manner; and
a sheet information acquisition step that acquires information relating to the sheet size in the feeding direction of a sheet to be switched back, wherein
the drive control step controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition step has acquired.

7. A sheet feeding method comprising:
a drive control step that controls drive of feeding rollers that guide a sheet to a reverse feeding path and then feed the sheet in a switchback manner to an image forming position where an image is to be formed on the sheet or a predetermined discharge position through which the sheet is to be discharged; and
a sheet information acquisition step that acquires information relating to the sheet size in the feeding direction of a sheet to be switched back, wherein
the drive control step controls drive of the feeding rollers in such a manner as to make the introduction speed of only the sheet having a predetermined size into the reverse feeding path lower than the introduction speed of other sheets having a size smaller than the predetermined size based on the information relating to the sheet size in the feeding direction thereof that the sheet information acquisition step has acquired in the case where a sheet to be switched back is fed to the image forming position where an image is to be formed on the sheet.
